(19) United States
(12) Patent Application Publication
(10) Pub. No.: US 2026/0060212 A1
(43) Pub. Date: Mar. 5, 2026

(54) DOG TRAINING DUMMY DEVICE

(71) Applicant: D.T. SYSTEMS, INC., Dallas, TX (US)

(72) Inventors: Bryant Y. KIM, Dallas, TX (US); Brian LASLEY, Tignall, GA (US)

(21) Appl. No.: 18/818,089

(22) Filed: Aug. 28, 2024

(51) Int. Cl. A01K 15/02

(52) U.S. Cl. CPC A01K 15/02

(57) ABSTRACT

A launchable dummy and launchable dummy system that include pressure-relief functionality, which may include a hole in the side of the body of the dummy or a widened cavity section. The launchable dummy and launchable dummy system include a cavity in the body of the dummy to accept a barrel from a launcher. In some embodiments, the cavity has two sections, with a first section having a larger diameter than a second section, and with the pressure-relief hole connecting the first section to an exterior of the body of the dummy. In some embodiments, the cavity has a tapered section between the first and second sections that includes a gradual change in diameter. In some embodiments, the launchable dummy and launchable dummy system include two or more pressure-relief holes.

### FIELD OF THE INVENTION

The present invention is related to dog training systems, launchable dummies, and related components.

### BACKGROUND OF THE INVENTION

Dogs love fetching toys. Dog owners—and dog trainers—may throw a ball for a dog, then wait for the dog to run to the ball, grab the ball, and bring the ball back to them. Training dummies function in a similar way. Dummies are thrown, then the dog locates and retrieves the dummy. While people often play fetch with dogs solely for the dogs' amusement, dummies are also often used to prepare the dogs for hunting. Launchable dummies are dummies that are thrown using a mechanical or explosive device. For example, some launchable devices use a blank firearm-style cartridge (i.e., a cartridge not having a bullet) to propel the dummy. These generally function by fitting the dummy over a barrel of a launcher, fitting a blank cartridge into the launcher so that it is lined up with the barrel, then igniting the blank cartridge so that it causes the dummy to slide off the barrel. Some explosive-style launchers like that can launch dummies over 50 yards.

To understand the advantages of launchable dummy systems, imagine the following scenario. You are waiting on the edge of a lake for a migratory bird to fly in, and—when one finally does—you shoot it. Thanks to your practice at the gun range, your shot lands, and the bird falls into the lake. But the bird is far out of your reach, and getting to and located the bird are two challenges that you are not wanting to deal with. Luckily, your dog is with you and loves retrieving balls. But your dog, having only been trained on tennis balls or dummies thrown by hand, was not accustomed to the sound of gunshots. Your dog was startled by the gunshot and reflexively looked at you when the gun went off instead of watching the bird fall from the sky. Not only is your dog too startled to jump into the water and retrieve the bird, but even if she did, she wouldn't know which way to swim or how far.

Launchable dummies help your dogs get accustomed to the sounds of gunshots, and help them learn to look for shot animals upon hearing a gunshot. Some dummies can be launched into the air to train the dog to look for something falling from the sky upon hearing a gunshot. And some dummies can be launched toward the ground to train the dog to look for shot rabbits.

Not all launchable dummies are optimized for every training scenario, however. For example, some scenarios need dummies that behave differently in the air, or that travel lower distances. There is tremendous value in identifying which characteristics of a dummy need to be changed to improve the dummy's use for training dogs. This invention improves dummies for some particular identified scenarios, the identification of which may be novel. More specifically, this invention may improve the user experience associated with operating a launchable dummy, may be more versatile in its use, or may lead to a better learning curve for dogs.

### SUMMARY OF THE INVENTION

The present disclosure is directed to a launchable dummy and launchable dummy system that include pressure-relief functionality, which may include a hole in the body of the dummy or a widened cavity section. The launchable dummy and launchable dummy system include a cavity in the body of the dummy to accept a barrel from a launcher. In some embodiments, the cavity has two sections, with a first section having a larger diameter than a second section, and with the pressure-relief hole connecting the first section to an exterior of the body of the dummy. In some embodiments, the cavity has a tapered section between the first and second sections that includes a gradual change in diameter. In some embodiments, the launchable dummy and launchable dummy system include two or more pressure-relief holes.

In some embodiments, a launchable dummy may comprise: a body having a top, a bottom, and a side extending between the top and the bottom. In some embodiments, the body may comprise: a cavity in the bottom and extending toward the top, wherein the cavity can fit over at least part of a barrel of a launcher; and a pressure-relief hole extending from the cavity to an exterior of the body, wherein when the barrel is positioned inside the cavity, and the launcher is activated, pressure builds up inside the cavity causing the launchable dummy to move away from the launcher, and some pressure is released from the cavity through the pressure-relief hole before the launchable dummy entirely leaves the barrel.

In some embodiments, the body further comprises a second pressure-relief hole extending from the cavity to an exterior of the body; and pressure relief from the second pressure-relief hole balances pressure relief from the first pressure-relief hole during operation of the launcher.

In some embodiments, at least part of the body is cylindrical; at least part of the barrel is cylindrical; and at least part of the cavity is cylindrical.

In some embodiments, the launchable dummy further comprises a dummy cushion, wherein the dummy cushion: is in contact with at least part of the exterior of the body; and is formed of a softer material than the body. In some embodiments, the dummy cushion covers all of the top of the body and at least part of the side of the body.

In some embodiments, the cavity comprises a top section and a bottom section; the bottom section is wider than the top section; the top section is wider than the barrel; the bottom section is near the bottom of the body, and the top section is toward the top of the body; and the pressure-relief hole extends from the bottom section of the cavity to the exterior of the body. In some embodiments, the cavity further comprises a tapering section between the bottom section and the top section; and the tapering section gradually decreases in width between the bottom section and the top section.

In some embodiments, a launchable dummy may comprise: a body having a top, a bottom, and a side extending between the top and the bottom. In some embodiments, the base may comprise: a cavity in the bottom of the body and extending toward the top of the body, wherein the cavity has: a bottom section located at the bottom of the body and having a first width, and a top section located toward the top and having a second width, wherein the second width is smaller than the first width, and wherein the second width is larger than a width of a barrel of a launcher; and a pressure-relief hole in the body and extending from the bottom section of the cavity to an exterior of the body.

In some embodiments, the cavity further comprises a tapering section between the bottom section and the top section; and the tapering section gradually decreases in width between the bottom section and the top section.

In some embodiments, the body further comprises a second pressure-relief hole; the second pressure-relief hole extends from the bottom section of the cavity to the exterior of the body; and the second pressure-relief hole is positioned at a different location between the top and the bottom of the body from the first pressure-relief hole.

In some embodiments, at least part of the body is cylindrical; at least part of the barrel is cylindrical; the first width is a maximum diameter of the bottom section of the cavity; and the second width is a maximum diameter of the top section of the cavity.

In some embodiments, the cavity further comprises a tapering section between the bottom section and the top section; the tapering section gradually decreases in width between the bottom section and the top section; the bottom section of the cavity comprises a bottom cylindrical section; the top section of the cavity comprises top cylindrical section; and the tapering section forms a conical frustrum between the bottom cylindrical section and the top cylindrical section.

In some embodiments, the launchable dummy further comprises a dummy cushion, wherein the dummy cushion: is in contact with at least part of the exterior of the body; and is formed of a softer material than the body. In some embodiments, the dummy cushion covers all of the top of the body and at least part of the side of the body.

In some embodiments, the body further comprises: a top stopper at the top of the body configured to hold a cushion in place on the body; and a bottom stopper at the bottom of the body configured to contact a top plate of the launcher when the barrel is inserted into the cavity, wherein: the top stopper and the bottom stopper each are wider than all other portions of the body; and the cavity terminates at or before reaching the top stopper.

In some embodiments, a launchable dummy system may comprise a launcher, a dummy body, and a dummy cushion. In some embodiments, the launcher may comprise a top portion comprising a top plate fixed to a barrel, wherein the barrel has a top and bottom; and a bottom portion comprising a handle and firing pin, wherein the bottom portion is attached to the top portion such that: the top plate is held in place relative to the handle with a latch, and the firing pin, when triggered, contacts a casing of a firearm cartridge associated with the barrel. In some embodiments, the dummy body may have a top, a bottom, and a side extending between the top and the bottom. In some embodiments, the body may comprise: a cavity in the bottom and extending toward the top, wherein the cavity can fit over at least part of the barrel of the launcher, and a pressure-relief hole extending from the cavity to an exterior of the body, wherein when the barrel is positioned inside the cavity, and the launcher is activated, pressure builds up inside the cavity causing the launchable dummy to move away from the top plate, and some pressure is released from the cavity through the pressure-relief hole before the launchable dummy entirely leaves the barrel. In some embodiments, the dummy cushion may be secured in contact with at least part of the dummy body.

In some embodiments, the body further comprises a second pressure-relief hole extending from the cavity to an exterior of the body; and pressure relief from the second pressure-relief hole balances pressure relief from the first pressure-relief hole during operation of the launcher.

In some embodiments, the cavity comprises a top section and a bottom section; the bottom section is wider than the top section; the top section is wider than the barrel; the bottom section is near the bottom of the body, and the top section is toward the top section of the body; and the pressure-relief hole extends from the bottom section of the cavity to the exterior of the body. In some embodiments, the cavity further comprises a tapering section between the bottom section and the top section; and the tapering section gradually decreases in width between the bottom section and the top section.

In some embodiments, at least part of the body is cylindrical; at least part of the barrel is cylindrical; and at least part of the cavity is cylindrical.

### BRIEF DESCRIPTION OF THE DRAWINGS

FIG. 1 is a diagram that depicts a prior-art launcher.

FIG. 2 is a diagram that depicts a cross section of the prior-art launcher of FIG. 1.

FIG. 3 is a diagram that depicts a launchable dummy system.

FIG. 4 is a diagram that depicts an exploded view of a launchable dummy.

FIG. 5 is a diagram that depicts a body of a launchable dummy.

FIG. 6 is a diagram that depicts a body of a launchable dummy.

FIG. 7 is a diagram that depicts a body of a launchable dummy.

FIG. 8 is a diagram that depicts a cross section of a body of a launchable dummy.

FIG. 9 is a diagram that depicts a cross section of a launchable dummy system.

### DETAILED DESCRIPTION

The following detailed description includes exemplary embodiments of the disclosed invention. The figures illustrate some of those embodiments. The term “may” in relation to a feature described in this specification indicates that the feature can be present in some embodiments, and can be omitted in other embodiments: “may” is used to describe an example that might be present in some embodiments. If an optional feature includes multiple components, each component can be independently included in an embodiment unless the specification indicates that two or more of the components must be coupled together. The term “or” in a string of two or more options means “and/or” unless the context indicates otherwise: the term “or,” when joining a string of two or more options, indicates that a combination of one or more of the options can be selected for an embodiment.

This invention improves upon existing launchable dummy systems, devices, and components. Identification of functionality improvements that could be relevant to this field might itself be novel.

In some embodiments of the invention, the dummies may be quieter when launched. As explained in the background section, the gunshot sound when a dummy is launched is beneficial and desired. The gunshot sound gets dogs accustomed to hearing guns, and accustomed to looking for a shot animal in response to hearing the sound. This helps the dog with locating and retrieving the shot animal. But there may be benefits to using less sound in training than in the field. This may be counter-intuitive since hunters often wish to replicate the real-life scenarios as much as possible when training.

There are several scenarios where a quieter dummy-launch may be desired. A first scenario is when you want to train your dog in a residential or other non-remote area, and you do not want to upset or startle people nearby with the sound of loud gunshots. A second scenario is when first introducing dogs to guns: it may be optimal to start the dog off with quieter bangs prior to exposing them to the full gunshot sound. A third scenario is when the person operating the device prefers to not wear ear protection, or when other people nearby refuse to do so. Louder noises can hurt people's ears, and can cause hearing damage. For a similar reason, it may be preferable to reduce the frequency in which dogs are exposed to loud gunshot bangs.

While at least some sound may be helpful for training, too much sound may restrict the locations where dogs can be trained, and may reduce the user experience. And the dogs might even learn to be comfortable with guns sooner if their first exposures to gunshots is muffled. Noise reduction may be achieved by expanding the duration in which pressure leaves the system, such as by adding pressure-relief holes or by widening the cavity relative to a barrel or barrel o-ring.

In addition to the advantages to reducing the sound of a launchable dummy, some embodiments have additional, more-nuanced advantages. For example, the sound-reduction may be specific to the dummy, and the launcher may be compatible with both standard dummies and sound-reduced dummies. This may allow a dog trainer to use quieter dummies in urban environments, and louder dummies in rural environments. Or a customer may start with quieter dummies as a warmup for his dog before launching the louder dummies.

Some embodiments may have further advantages related to how the noise-reduction is achieved. For example, some embodiments may reduce abrasion and destruction of components of the dummy-launcher system by adding tapering or expansion sections to a cavity in the dummy.

As a more concrete example, in some embodiments, a dummy may have one or more holes for releasing air during the launch, and those holes may reduce the sound of the launch by relieving pressure inside the dummy prior to the dummy entirely leaving a barrel of the launcher. This may be viewed as effectively extending the period of time in which pressure may escape the device, leading to a longer but less loud explosion sound. Instead of air escaping the dummy only at the time the dummy leaves the barrel, some air can escape earlier, and that pressure reduction at the time the dummy leaves the barrel reduces the noise. In some embodiments, a pressure-release hole located on a dummy may be easier to manufacture than other noise-reducing solutions, since it can be created quickly with a drill press, or similar mechanism, instead of needing complicated machining processes.

But those holes on the inside of the dummy may damage other components of the dummy launcher system. For example, the holes may rub against and damage a sealing ring (e.g., rubber o-ring) located on a launcher barrel. Even if not in direct contact with the sealing ring, a close proximity to the hole may cause an abrasion based on pressure differences and airflow at the location of the hole, which may act on the sealing ring as the two pass one another. In some embodiments, this issue may be solved through increasing the diameter of the cavity at a location along the dummy where the hole is located. In some embodiments, the issue may be further alleviated by including tapering (or expansion sections), which may make changes in pressure in the cavity less drastic, or may reduce drag or turbulence in sections of the inside of the dummy.

Additionally, widening of the cavity toward the bottom of the dummy, relative to the barrel or an o-ring associated with the barrel, may itself reduce the loudness of the dummy launching system by allowing pressure to slowly escape around the barrel or o-ring prior to the barrel or o-ring exiting the dummy, and by allowing the pressure to spread out in a larger volume. Increasing the duration of pressure release may reduce the loudness of the system. A dummy with a cavity that is tight around a barrel may help with directionality and with building up speed of the dummy, and a wider cavity may extend the time of pressure release by allowing air to escape the system.

Furthermore, some embodiments may include multiple holes in the dummy, which may increase the amount of pressure released, or may distribute the release of pressure around the perimeter (e.g., circumference) of the dummy. For example, in some embodiments there may be two holes, each on opposite sides of the dummy; or there may be three holes, each spaced at equal distances from the other two. Balancing the holes along the dummy may improve the flight path of the dummy, or may prevent the dummy from turning and pinching the barrel during launch.

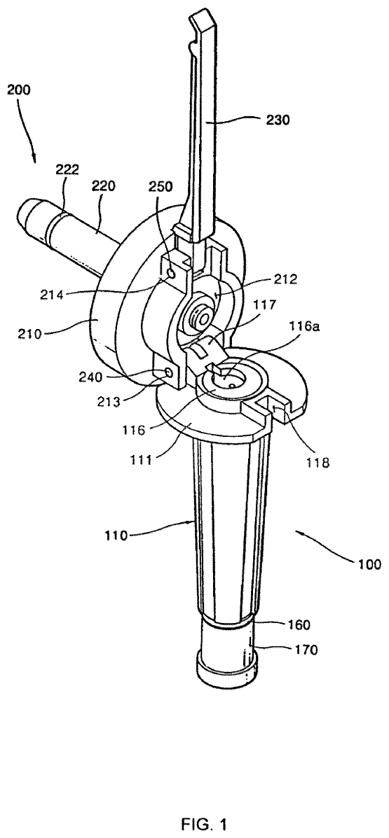

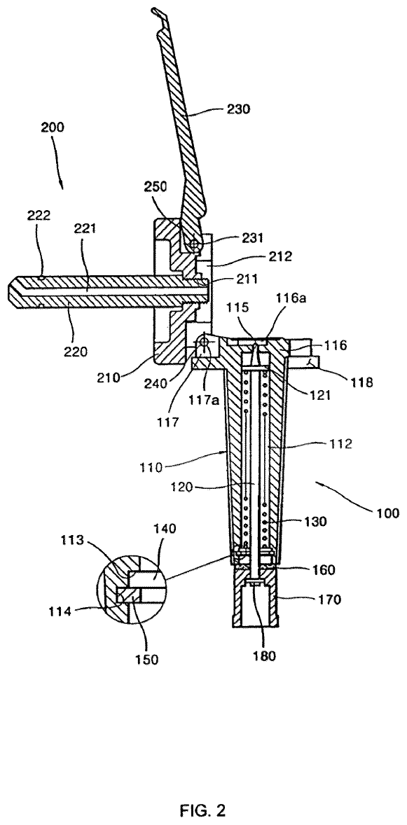

FIG. 1 is a diagram that depicts a launcher. FIG. 2 is a diagram that depicts a cross section of the launcher of FIG. 1. These diagrams are described in U.S. Pat. No. 7,076,901, filed by D.T. Systems, Inc., and provide an overview of the components and functionality of some dummy launchers.

As depicted in FIGS. 1 and 2, the launcher includes a firing assembly 100 and fixed assembly 200.

The firing assembly 100 has a body 110, fixed piece 111, housing 112, locking projection 113, groove 114, mounting hole 115, supporting protrusion 116, supporting groove 116a, supporting piece 117, supporting aperture 117a, fixed groove 118, firing pin 120, spring 130, supporting plate 140, locking ring 150, rubber plate 160, pulling member 170, and o-ring 180.

The fixed assembly 200 has a member 210, coupling hole 211, housing groove 212, barrel 220, passageway 221, rubber ring 222, locking arm 230, rotary hole 231, first fixed pin 240, and second fixed pin 250.

To the extent the features of the launchers of FIGS. 1 and 2 are not understood by a person of skill in the art, the disclosures of U.S. Pat. No. 7,076,901—which are incorporated herein—describe those features.

In some embodiments, the launchable dummy of the present invention can be used with the launcher of FIGS. 1 and 2. In some embodiments, such launcher and launchable dummies can be combined to form a launchable dummy system.

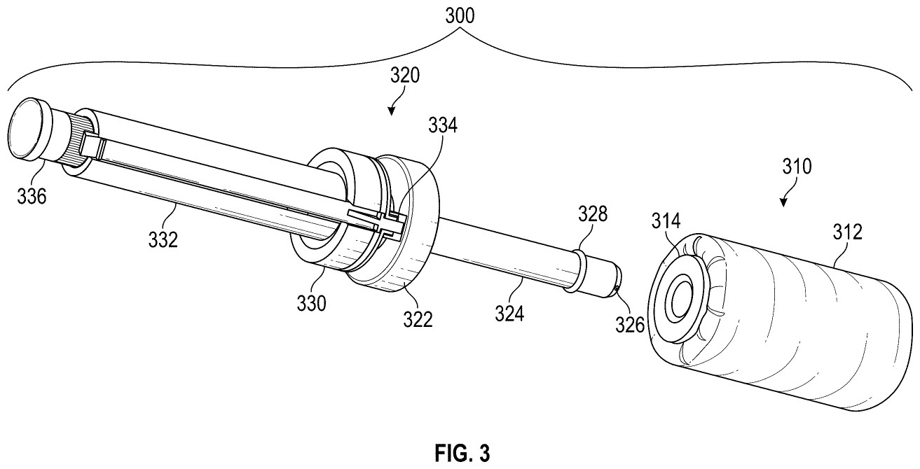

FIG. 3 is a diagram that depicts a launchable dummy system 300. The launchable dummy system 300 comprises a launchable dummy 310 and a launcher 320.

The launchable dummy 310, as illustrated, has a cushion 312 and a body 314. The body 314 may be made of metal, such as aluminum or stainless steel. The cushion 312 may be made of a softer material, such as a foam or cloth material. In some embodiments, the cushion 312 comprises materials that float so that the launchable dummy 310 can be launched into a body of water, such as a lake or pond, and can be retrieved from the surface by a dog. In embodiments where it is desirable for a dog to bite the launchable dummy 310 directly, the cushion 312 should be made of a material that is conducive to biting.

The launcher 320, as illustrated, has a top plate 322 pivotably attached to a bottom plate 330, where pivoting of the top plate 322 relative to the bottom plate 330 can be impeded with a latch 334 (which holds the plates in proximity of one another). The top plate 322 is attached, either directly or indirectly, to the barrel 324. The barrel 324 has an o-ring 328 and a barrel hole 326. As can be seen, the barrel has a cylindrical section between the o-ring 328 and the top plate 322, and is substantially cylindrical on the other side of the o-ring 328 toward the barrel hole 326. The barrel 324 is narrow enough to fit into the cavity (which is partially visible in FIG. 3) of the body 314. The cavity extends from the bottom (visible) of the body 314 toward the top (not visible) of the body 314. The o-ring 328 may function to provide a seal between the barrel 324 and the inside of the body cavity when the barrel 324 is inserted into the body 314. The barrel hole 326 is an exit point of a passageway through the barrel 324 that allows gas and vapor to escape the barrel 324 after firing of a blank cartridge. A blank cartridge may be inserted into a chamber associated with the barrel 324 in a location between the top plate 322 and bottom plate 330.

The bottom plate 330 is attached to the handle 332. A firing rod 336 extends partially outside of the handle 332. Though not depicted, there is a firing pin associated with the handle 332, firing rod 336, and bottom plate 330 such that when a user holds the handle 332 with one hand, holds the firing rod 336 with another hand, pulls his hands apart, then releases his grip on the firing rod 336, the firing pin moves suddenly at a location between the bottom plate 330 and top plate 322 in a manner similar to a firing pin of a handgun. If a blank cartridge is chambered and the latch 334 is in a latched position, the firing pin may strike a primer of the cartridge, causing it to ignite the gun powder causing a desired explosion to flow through the barrel 324 and out the barrel hole 326. The barrel 324 may be inserted into the cavity of the barrel 314, for example, such that part of the body 314 (the bottom) is pressed against the top plate 322. In such a configuration, the explosion flowing through the barrel hole 326 may cause an increased pressure within the body 314, with the pressure being trapped or substantially trapped inside the cavity on the other side of the o-ring 328 from the top plate 322. Such pressure may cause the launchable dummy 310 to move along the barrel 324 in a direction away from the top plate 322. Eventually, the launchable dummy 310 may shift so far along the barrel 324 that the o-ring 328 will be external to the body 314, and air may be rapidly released. Such rapid release may cause a large sound, with the loudness of the sound being dependent on the amount of pressure build-up and the rate at which the pressure is released. Additional pressure may be released from the bottom of the cavity of the body 314 after the barrel entirely leaves the inside of the body 314.

Though not visible in FIG. 3, the body 314 may include one or more holes in its side, somewhere underneath the cushion 312. Such holes may release pressure from the cavity of the body 314—with the pressure escaping into the cushion 312—prior to the o-ring exiting the cavity of the body 314. This functionality may be described as releasing pressure in the cavity when the dummy 310 slides far enough off the barrel 324 that the hole is beyond the o-ring 328, then releasing more pressure when the bottom of the body 314 of the dummy slides beyond the o-ring 328. This functionality may also be described as trapping some of the air (i.e., hot gasses) in the cushion 312, or between the body 314 and cushion 312. In some embodiments, the location of the top of the barrel 324 may be more significant than the location of the o-ring 328 relative to the components of the body 314.

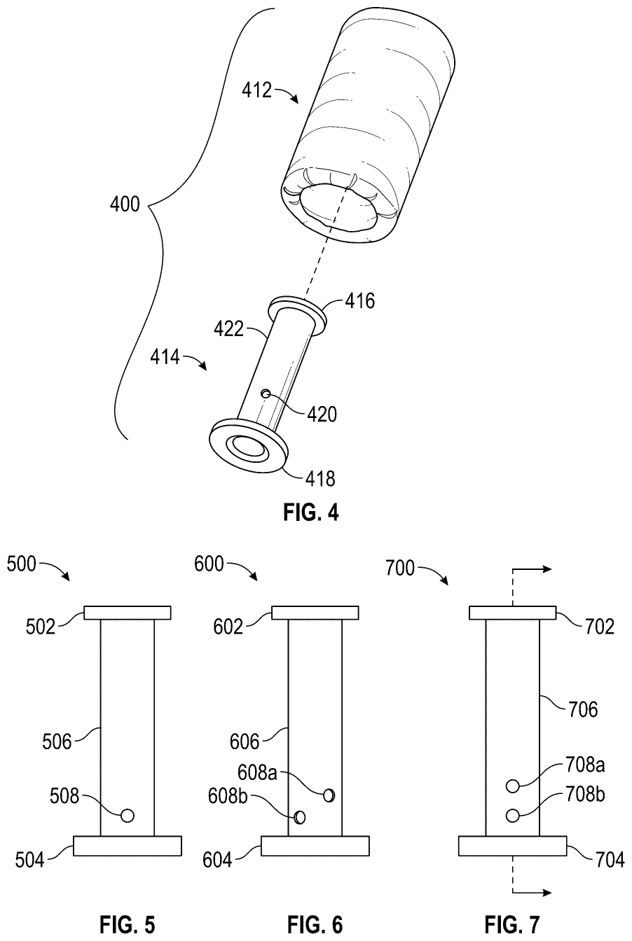

FIG. 4 is a diagram that depicts an exploded view of a launchable dummy 400. The launchable dummy 400 comprises a cushion 412 and a body 414. The body 414 comprises a top stopper 416, a bottom stopper 418, and a cylindrical section 422 between the top stopper 416 and bottom stopper 418. The cylindrical section 422 comprises a hole 420 that may allow for pressure release during operation of the dummy with a launcher.

The cylindrical section 422 is hollow at the bottom and at least part of the way to the top (forming a cavity), the bottom stopper 418 is a ring (a flat disc plate with hole in the center), and the top stopper 416 is a flat disc plate (no hole in center). The body 414 does not have a hole at the top, which creates a cavity inside the body 414 that can trap air. In some embodiments, the cylindrical section 422 is hollow all the way to the top stopper 416, and in other embodiments, the cylindrical section 422 is hollow only part of the way toward the top stopper 416.

When assembled, with the cushion 412 over the body 414, the top stopper 416 and bottom stopper 418 hold the cushion 412 in place on the body 414. When in operation, pressure can be relieved from the cavity through the hole 420.

FIG. 5 is a diagram that depicts a launchable-dummy body 500. The launchable-dummy body 500 comprises a top stopper 502, a bottom stopper 504, a cylindrical section 506 between the top stopper 502 and the bottom stopper 504, and a hole 508 located on, and piercing through, the cylindrical section 506 from an inside cavity of the launchable-dummy body 500 to an exterior of the launchable-dummy body 500. In some embodiments, the launchable-dummy body 500 may have a cushion around its exterior, and the cushion may cover the top stopper 502 and cylindrical section 506 but not the bottom stopper 504. A cushion may cover the hole 508; and, in such embodiments, gases and vapors relieved through the hole may travel through the cushion or between the body 500 and the cushion. The top stopper 502 or bottom stopper 504 may assist in maintaining a position of a cushion. The bottom stopper 504 may assist with positioning the launchable-dummy body 500 on a launcher.

In some embodiments, the body 500 comprises two holes, one on each side of the body 500, such that the hole 508 is in-line with the second hole (i.e., located on opposite sides of the cylindrical section 506 and at the same distance between the top stopper 502 and bottom stopper 504). In some embodiments, the body 500 comprises three holes, each offset by 120 degrees. Offsetting holes with uniform spacing around the circumference of the body 500 may have the advantage of creating a more uniform pressure release or flight pattern, which may balance the dummy.

FIG. 6 is a diagram that depicts a launchable-dummy body 600. The launchable-dummy body 600 comprises a top stopper 602, bottom stopper 604, and cylindrical section 606. It also comprises two holes 608a and 608b, located along the cylindrical section 606, which may contribute to pressure release from a cavity in the body 600 during operation of the body 600 with a launcher. As can be seen, the holes 608a and 608b are offset vertically and are positioned about 45 degrees from each other horizontally. In some embodiments, the body 600 may have additional holes along the perimeter of the cylindrical section 606. The offsetting of the holes 608a and 608b may allow the body 600 to relieve pressure through the first hole 608a before relieving pressure through the second hole 608b, which may advance a goal of reducing loudness of the body 600 when in operation with a launcher.

FIG. 7 is a diagram that depicts a launchable-dummy body 700. The body 700 comprises a top stopper 702, bottom stopper 704, and cylindrical section 706. It also comprises two holes 708a and 708b, located along the cylindrical section 706, which may contribute to pressure release from a cavity in the body 700 during operation of the body 700 with a launcher. As can be seen, the holes 708a and 708b are offset vertically and not offset horizontally. For some implementations, this positioning of holes may be advantageous, such as based on manufacturability or flight pattern.

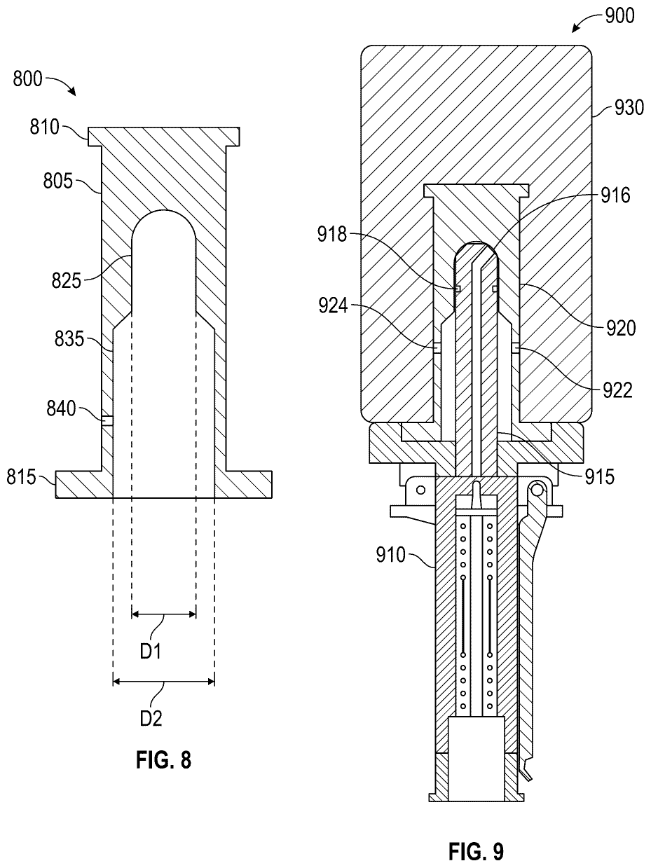

FIG. 8 is a diagram that depicts a cross section of a launchable-dummy body 800. The body 800 has a top stopper 810, a bottom stopper 815, and a cylindrical section 805 between the top stopper 810 and bottom stopper 815. The cylindrical section 805 has a narrow inside wall 825, a wide inside wall 835, and a hole 840 located along the wide inside wall 835 and penetrating from an inside of the cylindrical section 805 to an exterior of the cylindrical section 805.

As can be seen, the narrow inside wall 825 and wide inside wall 835 form a cavity having a narrow portion and wide portion, with a tapering section located between the narrow inside wall 825 and wide inside wall 835. The tapering section may have tradeoffs, such as increased manufacturing complexity and increased performance. Performance increase may be attributable to a more gradual change of diameter being less abrasive on the launcher barrel, on an o-ring, or on the body 800.

As can be seen, the narrow inside wall 825 and wide inside wall 835 have widths D1 and D2, which may be described as diameters in embodiments with components that are cylindrical in shape. In some embodiments, the components of the body 800, including the cylindrical section 805, may be non-cylindrical, such as by choosing a rectangular shape. However, cylindrical shapes may be advantageous for manufacturability and use, particularly because launchers on the market tend to have cylindrical (rather than rectangular) barrels.

As depicted, the cavity in the body 800 terminates within the cylindrical section 805 prior to reaching the top stopper 810. In some embodiments, the cylindrical section 805, top stopper 810, and bottom stopper 815 may be formed from one piece of metal.

FIG. 9 is a diagram that depicts a cross section of a launchable dummy system 900. The system 900 comprises a dummy body 920, a cushion 930 covering part of the body 920, and a launcher 910. The body 920 has two holes 922, 924. The launcher 910 has a barrel 915 inserted inside the dummy body 920. The barrel 915 has an o-ring 918 and a barrel hole 916.

In operation, when a firing pin in the launcher is activated, and a blank cartridge is ignited, an explosion in the launcher may cause an increase in pressure in the barrel 915, causing gases and vapors to leave the barrel hole 916. Then, the dummy (which, in this embodiment, includes the dummy body 920 and the cushion 930; in some embodiments, the dummy body 920 may be launched without a cushion) may slide off of the barrel. The o-ring 918 may function to seal (or substantially seal) the cavity inside the body 920 in the region above the o-ring 918 to help build up pressure in the cavity and propel the dummy. As the dummy slides off the barrel 915, the o-ring 918 may exit the narrow part of the cavity, which may allow air to pass over the barrel into the wide portion of the cavity. This air pressure may be released partially through the holes 922, 924. Then the barrel hole 916 may exit the narrow part of the cavity, and may further release pressure into the wide part of the cavity and partially exit the cavity through the holes 922, 924. The barrel 915 may then fully exit the cavity through the bottom of the body 920, and the remainder of the built-up pressure in the cavity of the body 920 may release through the bottom of the cavity and through the holes 922, 924. In such a configuration, the holes 922, 924 may reduce the noise of the launcher operation (assisted by the widened section), and the widened section of the cavity of the body 920 may reduce the abrasion of the o-ring 918 on the holes 922, 924.

The invention disclosed herein is susceptible to various modifications and alternative forms. Specific embodiments therefore have been shown by way of example in the drawings and detailed description. It should be understood, however, that the drawings and detailed description thereto are not intended to limit the invention to the particular form disclosed, but on the contrary, the invention is to cover all modifications, equivalents, and alternatives falling within the spirit and scope of the present invention as defined by the claims.

What is claimed is:

1. A launchable dummy comprising:
a body having a top and a bottom, wherein the body comprises:
a cavity in the bottom and extending toward the top, wherein the cavity can fit over at least part of a barrel of a launcher; and
a pressure-relief hole extending from the cavity to an exterior of the body, wherein when the barrel is positioned inside the cavity, and the launcher is activated, pressure builds up inside the cavity causing the launchable dummy to move away from the launcher, and some pressure is released from the cavity through the pressure-relief hole before the launchable dummy entirely leaves the barrel.

2. The launchable dummy of claim 1, wherein:
the body further comprises a second pressure-relief hole extending from the cavity to an exterior of the body; and
pressure relief from the second pressure-relief hole balances pressure relief from the first pressure-relief hole during operation of the launcher.

3. The launchable dummy of claim 1, wherein:
at least part of the body is cylindrical;
at least part of the barrel is cylindrical; and
at least part of the cavity is cylindrical.

4. The launchable dummy of claim 1, further comprising a dummy cushion, wherein the dummy cushion:
is in contact with at least part of the exterior of the body; and
is formed of a softer material than the body.

5. The launchable dummy of claim 4, wherein the dummy cushion covers all of the top of the body and at least part of the side of the body.

6. The launchable dummy of claim 1, wherein:
the cavity comprises a first section and a second section;
the first section is wider than the second section;
the second section is wider than the barrel;
the pressure-relief hole extends from the first section of the cavity to the exterior of the body.

7. The launchable dummy of claim 6, wherein:
the cavity further comprises a tapering section between the first section and the second section; and
the tapering section gradually changes in width between the first section and the second section.

8. A launchable dummy comprising:
a body having a top, and a bottom, wherein the body comprises:
a cavity in the bottom of the body and extending toward the top of the body, wherein the cavity has:
a bottom section located at the bottom of the body and having a first width, and
a top section located toward the top and having a second width, wherein:
the first width and second width are each larger than a width of a barrel of a launcher, and
the first width and second width are different.

9. The launchable dummy of claim 8, wherein:
the cavity further comprises a tapering section between the bottom section and the top section; and
the tapering section gradually changes in width between the bottom section and the top section.

10. The launchable dummy of claim 8, wherein the body further comprises a pressure-relief hole in the body and extending from the cavity to an exterior of the body.

11. The launchable dummy of claim 8, wherein:
at least part of the body is cylindrical;
at least part of the barrel is cylindrical;
the first width is a maximum diameter of the bottom section of the cavity; and
the second width is a maximum diameter of the top section of the cavity.

12. The launchable dummy of claim 8, wherein:
the cavity further comprises a tapering section between the bottom section and the top section;
the tapering section gradually changes in width between the bottom section and the top section;
the bottom section of the cavity comprises a bottom cylindrical section;
the top section of the cavity comprises top cylindrical section; and
the tapering section forms a conical frustrum between the bottom cylindrical section and the top cylindrical section.

13. The launchable dummy of claim 8, further comprising a dummy cushion, wherein the dummy cushion:
is in contact with at least part of an exterior of the body; and
is formed of a softer material than the body.

14. The launchable dummy of claim 13, wherein the dummy cushion covers all of the top of the body and at least part of a side of the body.

15. The launchable dummy of claim 8, wherein the body further comprises:
a top stopper at the top of the body configured to hold a cushion in place on the body; and
a bottom stopper at the bottom of the body configured to contact a top plate of the launcher when the barrel is inserted into the cavity, wherein:
the top stopper and the bottom stopper each are wider than all other portions of the body; and
the cavity terminates at or before reaching the top stopper.

16. A launchable dummy system comprising:
a launcher comprising:
a top portion comprising a top plate attached to a barrel; and
a bottom portion comprising a handle and firing pin, wherein the bottom portion is attached to the top portion such that:
the top plate is held in place relative to the handle with a latch, and
the firing pin, when triggered, contacts a casing of a firearm cartridge associated with the barrel;
a dummy body having a top, and a bottom, wherein the dummy body comprises:
a cavity in the bottom and extending toward the top, wherein the cavity can fit over at least part of the barrel of the launcher, and
a pressure-relief hole extending from the cavity to an exterior of the body, wherein when the barrel is positioned inside the cavity, and the launcher is activated, pressure builds up inside the cavity causing the launchable dummy to move away from the top plate, and some pressure is released from the cavity through the pressure-relief hole before the launchable dummy entirely leaves the barrel; and
a dummy cushion secured in contact with at least part of the dummy body.

17. The launchable dummy system of claim 16, wherein:
the body further comprises a second pressure-relief hole extending from the cavity to an exterior of the body; and
pressure relief from the second pressure-relief hole balances pressure relief from the first pressure-relief hole during operation of the launcher.

18. The launchable dummy system of claim 16, wherein:
the cavity comprises a first section and a second section;
the first section is wider than the second section;
the second section is wider than the barrel; and
the pressure-relief hole extends from the first section of the cavity to the exterior of the body.

19. The launchable dummy of claim 18, wherein:
the cavity further comprises a tapering section between the first section and the second section; and
the tapering section gradually changes in width between the first section and the second section.

20. The launchable dummy system of claim 16, wherein:
at least part of the body is cylindrical;
at least part of the barrel is cylindrical; and
at least part of the cavity is cylindrical.
